(19) United States
(12) Patent Application Publication
(10) Pub. No.: US 2004/0032052 A1
(43) Pub. Date: Feb. 19, 2004

(54) Method of making a foot orthotic device

(76) Inventors: Andrew H. Meyers, Roslyn Estates, NY (US); Chad McDaniel, Washington, DC (US); Justin Wernick, New York, NY (US)

Correspondence Address: JAMES & FRANKLIN, LLP., 60 East 42nd Street, New York, NY, 10165, US

(21) Appl. No.: 10/219,088

(22) Filed: Aug. 16, 2002

(51) Int. Cl. G06F 19/00

(52) U.S. Cl. 264/219; 700/117; 600/592

(57) ABSTRACT

To make a foot orthotic device shaped to correct the plantar surface of a patient's foot from an appropriately shaped body, that body is made by taking measurements of various characteristics of the patient's foot directly from that foot, including measurements of various aspects of the patient's arch, generating a model of the plantar surface of the foot from these measurements, then modifying this model in accordance with a practitioner's corrective prescription, and using those modified measurements to control a shaping device such as a milling machine to produce on said body a three-dimensional surface constituting the desired corrected shape for the patient's plantar surface.

The present invention relates to a method for making an orthotic device shaped to correct the plantar surface of a patient's foot from measurements taken directly from that foot.

### BACKGROUND OF THE INVENTION

Foot orthoses of the type here involved are conventionally made by forming the orthotics, the shell of which is usually constituted by a plastic material, on an appropriately three-dimensionally shaped surface of a supporting body. That surface is shaped to produce the desired corrective effect by taking into account the existing plantar surface of the patient's foot and the desired modification of that surface shape as prescribed by the practitioner. Conventionally the practitioner makes a plaster mold or foam impression which is a negative version of the patient's plantar foot surface (the term “mold” will here be used generically to include both molds and impressions) and sends that mold to the orthotic manufacturer along with a prescription outlining the desired changes to be produced in that surface. The manufacturer then produces a body which carries a surface which is a positive version of the negative mold, traditionally by means of plaster poured into the mold. The thus produced positive version of the patient's plantar surface is then modified, usually by means of hand sculpting, in accordance with the practitioner's prescriptions. The material for the shell of the orthotic device is then formed and shaped by being applied to that three-dimensional surface so that, when the orthotic is used by the patient, it will produce the desired corrective effect.

This procedure, though almost universally used for many years, has many drawbacks—to make the original mold is messy and subject to error, when that mold is sent to the manufacturer it is subject to distortion, foam impressions in particular are not precise, the use of plaster by the manufacturer to form the original positive version is dirty and inconvenient and requires considerable factory space, and the total process is quite time-consuming.

The assignee of the present invention improved on the conventional procedure by eliminating the creation of a positive cast from a negative mold and the need for hand sculpting. Instead, it took the conventional negative molds sent to it by the practitioner, made certain measurements of those casts, and used those measurements to create, by means of software, a three-dimensional mathematical model of the plantar surface of the patient's foot which was then mathematically modified in accordance with the practitioner's prescription, and the resultant mathematical model was then used to formulate commands to a milling machine which, acting on a body of suitable material such as wood, created on that body a positive three-dimensional surface corresponding to the desired shape of the patient's plantar surface, and this surface was then used in conventional fashion to constitute the surface on which the orthotic device itself was formed and shaped. It was found that accurate measurements of heel width, forefoot width, and distance from heel to head of the first metatarsal, and by-eye assessment of arch type and arch height, could be used in that way with considerable reliability for the of orthotics for non-deformed, non-injury-modified feet. This procedure eliminated the need to create positive plaster casts from a negative mold and to hand-sculpt the positive casts, but it still involved the practitioner's taking molds of the patient's foot and sending those molds to the manufacturer with all of the disadvantages attendant creating and transporting those molds and measuring them at the manufacturing site.

### SUMMARY OF THE INVENTION

When a proper mold is made by the practitioner, careful manipulation of the patient's sub-talar joint and forefoot positions is required. That alone would seem to indicate the undesirability of taking measurements directly from the foot. The molds produced reflect these manipulations and hence the measurements taken on the molds themselves are prima facie different from measurements that might be taken on the non-manipulated foot, and hence taking measurements of the foot itself would appear to be contra-indicated—one would not expect that one could properly manipulate the ankle and foot while taking measurements directly from the foot. Moreover, the heel to first metatarsal head, heel width and forefoot width measurements which involved the ability to put a measuring device inside the mold, and the need for skill and training in making a by-eye assessment of arch height and arch type, appeared to be too difficult and uncertain if attempted to be made on the foot itself. These originally perceived limitations, plus the ingrained experience with using molds or impressions of the patient's foot to produce effective orthotics, militated against the idea of taking measurements directly from the patient's foot.

Nevertheless, after experimentation over a period of time, against conventional thinking, and despite what the history of the art taught, we have discovered that with feet which are not deformed or injury-modified, measurements may effectively be taken directly from the patient's foot, and used to make an accurate and effective corrective orthotic. Those measurements are converted by a computer provided with appropriate software, readily designable by a qualified software practitioner, into a mathematical model of the patient's actual plantar surface. That mathematical model can be modified in accordance with the prescription provided by the orthotic practitioner, and that modified mathematical model can be converted into signals sent to and controlling a shaping device such as a milling machine, in order to form on a body such as a block of wood a positive shaped surface conforming to the plantar surface desired on the corrective orthotic. The orthotic can then be formed on that surface in conventional fashion. Thus it is no longer necessary to make a mold of the patient's foot or to send such a fragile mold to the manufacturer. What is sent to the manufacturer in accordance with the present invention are pieces of paper or electronic or other equivalents thereof carrying the measurements and the practitioner's prescription, which information can be easily sent, received and stored without danger of damage or distortion, and this results in a saving of time and space and minimizes required equipment and the need for skill on the part of both the practitioner and the manufacturer.

We have found, contrary to prior belief, that useful direct measurements of the foot are possible, and have also found that this direct-foot-measurement system calls for foot measurements different from and in addition to the measurements previously used for direct measurement of the submitted mold.

### BRIEF DESCRIPTION OF THE DRAWINGS

To the accomplishment of the above, and to such other objects as may hereinafter appear, the present invention relates to a direct-foot-measurement system of making a corrective orthotic, as defined in the following claims and as disclosed in the accompanying drawings in which:

FIG. 1 illustrates a set of simple tools which can be used in accordance with the present invention; and

FIGS. 2-10 illustrate a preferred set of measurements to be taken directly from the foot of the patient to accomplish the desired results.

### DESCRIPTION OF THE PREFERRED EMBODIMENT

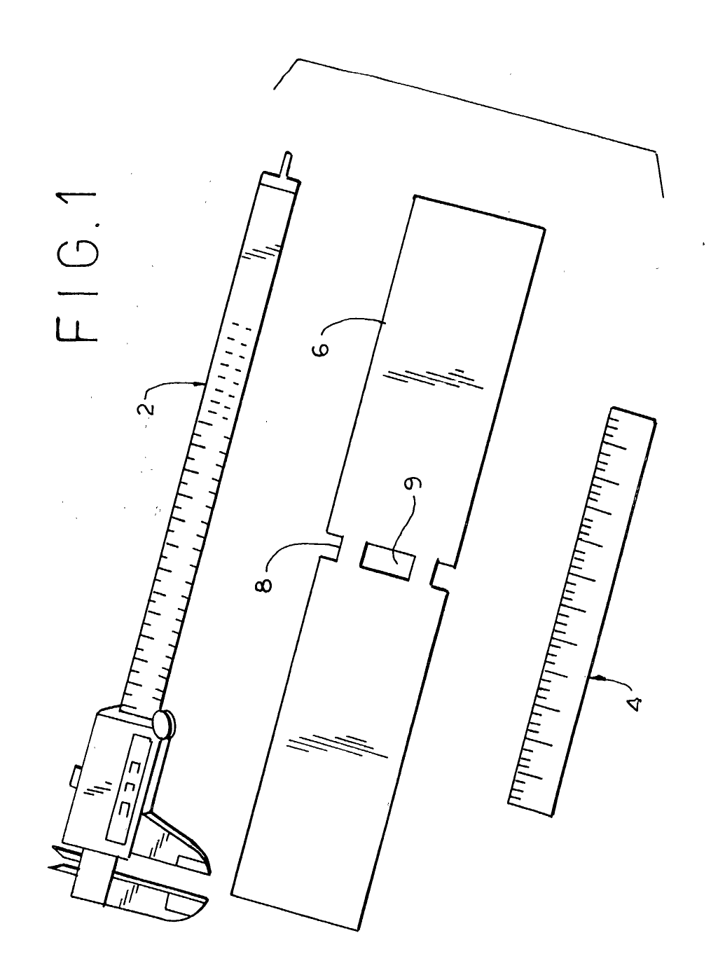

The process here disclosed can be carried out with the use of a minimal number of readily available tools. A single straight edge engineering ruler could be used for all of the measurements involved, but it is preferred to use the trio of tools shown in FIG. 1 comprising calipers 2, a straight edge ruler 4 and a flat strip 6 preferably having an edge slit 8 and a central slot 9, through either of which the ruler 4 is adapted to slide. These tools are all that is needed to carry out the specific measurements involved in the method here disclosed, but other tools could of course be used. The specific measurements hereinafter set forth constitute the preferred embodiment of the present invention, but other measurements, either in addition to or alternative with the disclosed measurements, may be used, it being further understood that in addition one or more of the specifically disclosed measurements may be eliminated. The foot measurements of the preferred embodiment are here described in an arbitrary sequence which may be altered at will. These measurements are taken by the practitioner from the actual foot of the patient while it is not weight-bearing, although it may be manipulated if appropriate. The measurements are then conveyed to the manufacturer simply in numerical form on a piece of paper such as a preprinted form or any other available means of communicating such information. The practitioner also sends to the manufacturer his prescription, indicating those changes that are appropriate to the foot correction that he wishes the orthotic to produce when used by the patient. The practitioner need not make a mold, and he need not worry whether the mold is damaged or distorted in transit to the manufacturer. The manufacturer likewise need not worry about damage to the non-existent mold, nor need the manufacturer take measurements from said problematic devices, nor provide storage for such devices.

Two reference parameters involved in the disclosed measurements are the midline of the foot and the medial arch line. The midline of the foot is the line along the long axis of the foot that bisects the heel and runs through the interstice between the second and third metatarsal heads. The medial arch line is determined by placing the edge of a guide such as the flat strip 6 to bisect the first metatarsal head and be tangential to the medial-most aspect of the heel, the medial arch line being the line from the front to the back of the arch that is directly below that edge.

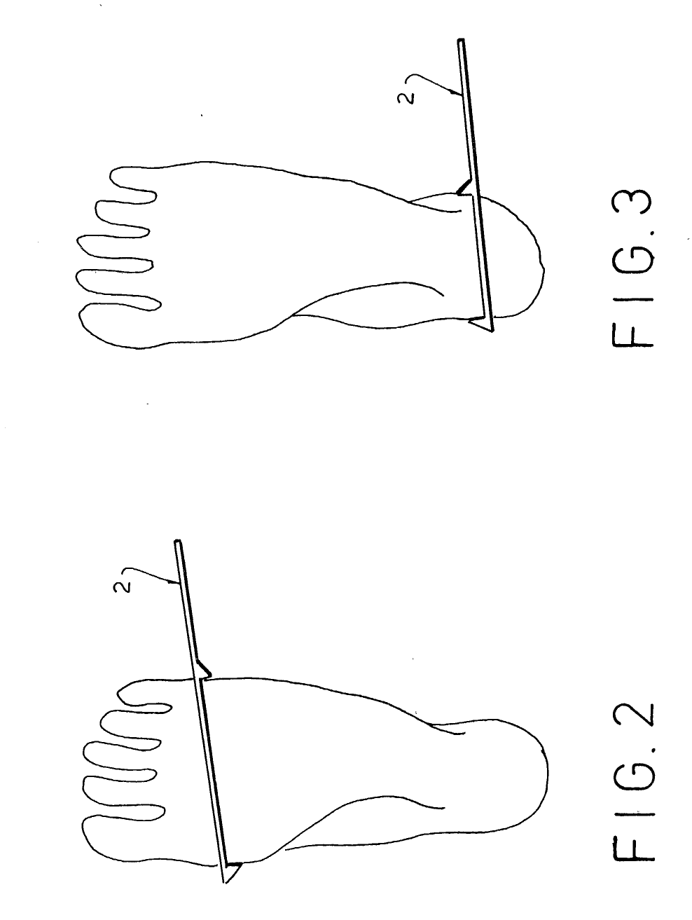

One measurement that we use is the forefoot width measured, as shown in FIG. 2, by using the calipers 2 to measure the distance from the medial exterior point of the foot that aligns with the head of the first metatarsal and the exterior lateral point of the foot that aligns with the head of the fifth metatarsal.

A second measurement is that of the heel width, as shown in FIG. 3, using the calipers 2 to measure the distance between the point on the lateral heel where the calcaneus has its lateral extension and the point on the medial side of the heel that is on the line perpendicular with the midline of the foot (as defined above) and which passes through the first mentioned point.

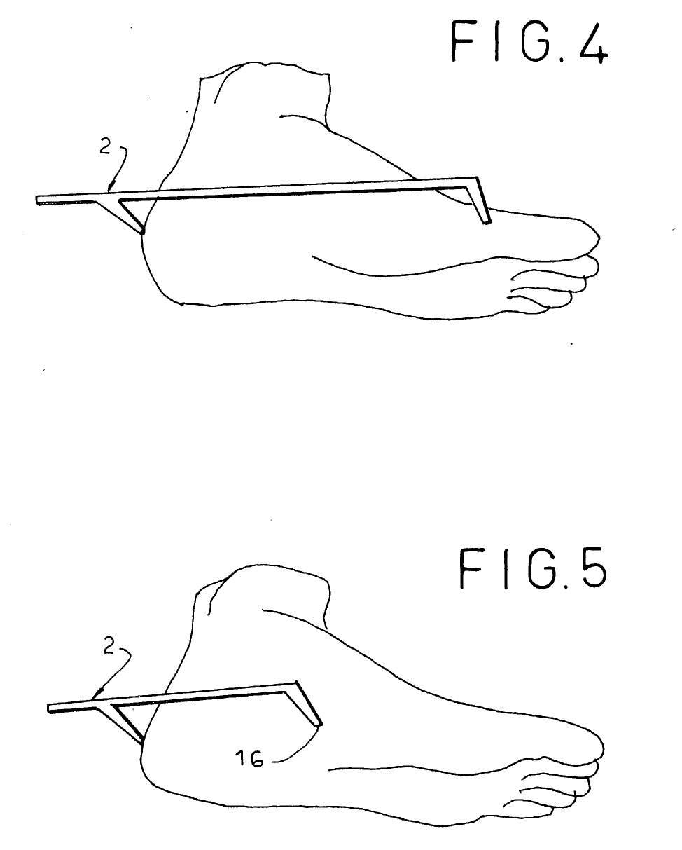

Another measurement, as illustrated in FIG. 4, is taken from the center of the most posterior part of the heel and the center of the first metatarsal head.

Another measurement is foot length to lateral arch, as shown in FIG. 5. This is measured between the lateral arch apex 16 and the center of the back of the heel. The lateral arch apex 16 is ascertained by palpating the fifth metatarsal base, placing one's thumb just proximal to it at the plantar surface of the calcaneal-cuboid joint, and marking the point at the center of the finger.

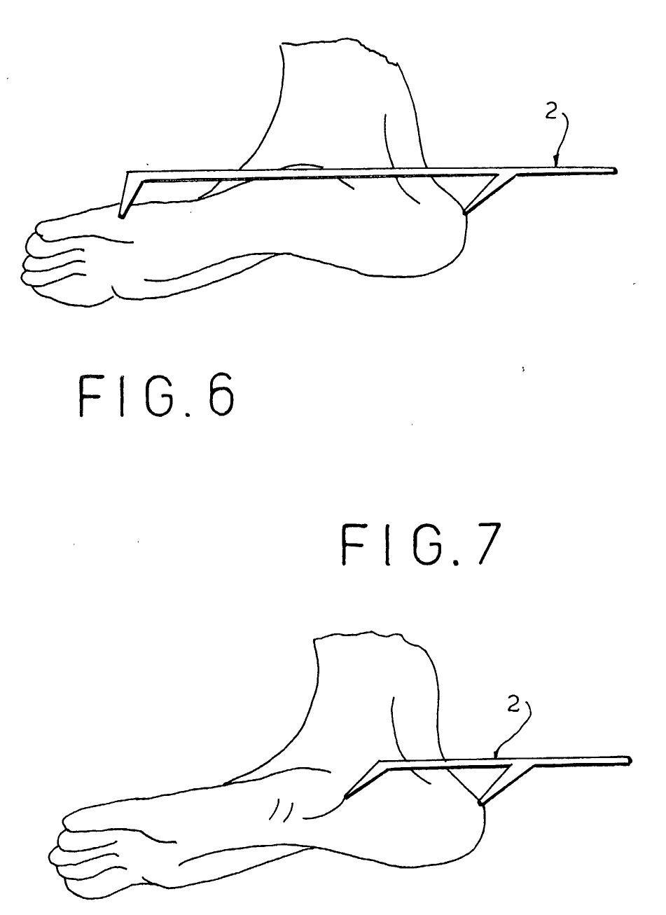

Another measurement, as illustrated in FIG. 6, is from the back of the heel, to wit, the center of the most posterior part of the heel, to the center of the fifth metatarsal head.

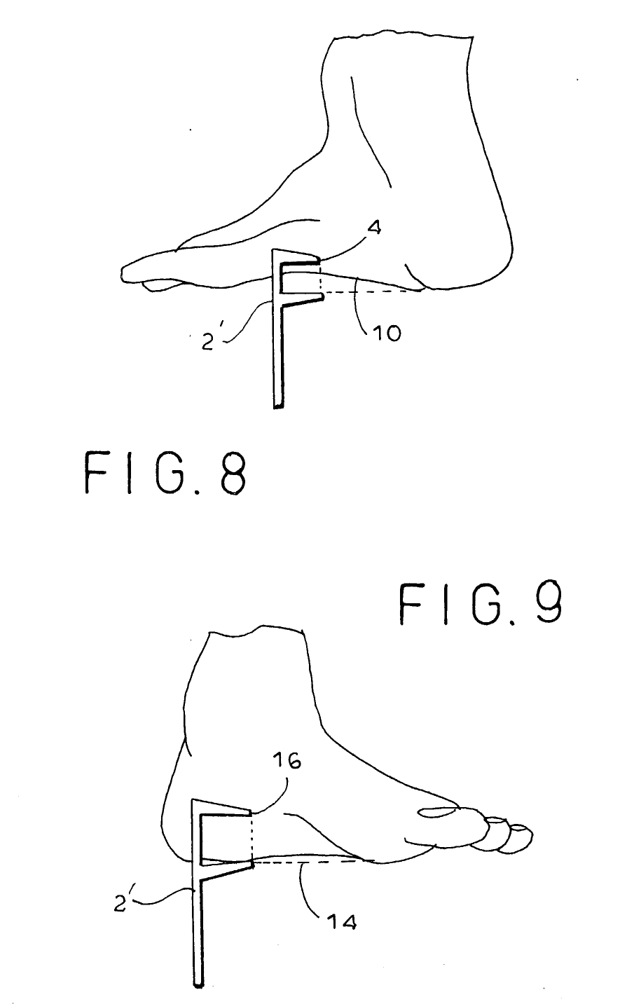

Another measurement is that of the medial arch height, as shown in FIG. 8. To make this measurement one draws on the foot the medial arch line as defined above. The practitioner then palpates the plantar-most surface of the prominence of the navicular and marks it with a vertical line. A line is then drawn down from the navicular mark so that the line drawn forms a perpendicular intercept with the horizontal arch line. This is the first reference point for the medial arch height measurement. To determine the other reference point one uses the flat strip 6 to extend between the bottom of the heel and the bottom of the foot below the first metatarsal. The medial arch height may be measured by sliding the ruler 4 upwardly through one of the slots 8 or 9 on the flat strip 6 until it meets the medial arch line apex, and then measuring the distance involved. On FIG. 8, the plane of the flat strip 6 is indicated by the dotted line 10, and the medial arch height is indicated by the dotted line 12. The measurement of the height 12 is indicated in this and other figures as being made by calipers 2′ instead of by the ruler 4 only for schematic purposes.

Another measurement, as indicated by FIG. 7, is the measurement of the foot length to the medial arch. This is a measurement between the medial arch apex point 11, defined above in connection with the measurement of the medial arch height, and the center of the back of the heel.

Another measurement is the lateral arch height which, as shown in FIG. 9, is determined by placing the flat strip 6 against the bottom of the heel and the bottom of the third through fifth metatarsal heads to define the plane indicated by the dotted line 14 in FIG. 9, the other measurement point 16 being the lateral arch apex as described in connection with FIG. 5.

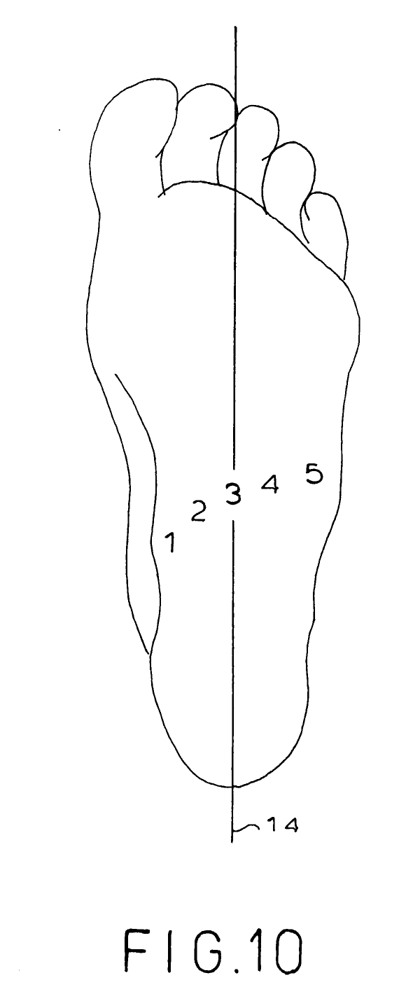

Another measurement is arch depth, as shown in FIG. 10. This reflects the relationship between the start of the medial arch and the midline 14 of the foot. Arbitrary values may be used, as shown in FIG. 10, to the location of the start of the medial arch.

The purposes here set forth, and the specific measurements here described, have been found to be adequate to produce corrective orthotics of accuracy and effectiveness equal to or superior to those produced by more conventional means yet with the advantages to the practitioner and to the manufacturer which have been described. However, modifications or substitutions of parameters and measurements, all within the skill and experience of the art, may be made without departing from the invention as hereinafter set forth.

We claim:

1. In connection with correcting a problem with a patient's foot by providing the patient with an orthotic device which modifies the existing plantar surface of the patient's foot, the method of making such an orthotic device which comprises:
(a) taking measurements of various characteristics of a patient's foot directly from that foot, including measurements of aspects of its plantar surface, thereby to produce a set of measured quantities for selected parameters of said foot;
(b) modifying a model of the plantar surface derived from these measurement quantities as appropriate to represent a modified plantar surface which corrects the patient's problem, producing thereby a modified set of measurement quantities;
(c) using said modified measurement-based model to control a shaping device active on a body to produce on said body a three-dimensional surface representative of the modified plantar surface; and
(d) producing from said three-dimensional surface representation on said body a correspondingly shaped orthotic to correct the patient's problem.

2. The method of claim 1, in which step (c) comprises:
(a) using said modified measurement-based model;
(b) providing (1) a shapable object with an exposed surface and (2) a forming apparatus capable of acting on said exposed surface to change the 3-dimensional contour thereof; and
(c) actuating said forming apparatus pursuant to said modified set of measurement-based model to act on said exposed body surface to cause said surface to assume the desired representation of said modified plantar surface.

3. The method of either of claims 1 or 2, in which measurements of said various foot characteristics comprise measurements of heel width, forefoot width, metatarsal location, and location and shape of arch.

4. The method of either of claims 1 or 2, in which measurements of said various foot characteristics comprise measurements of heel width, forefoot width, distance from heel to different metatarsal heads, lengthwise location of arch, arch height and arch depth, all of said measurements being in linear dimensional amounts with the possible exception of the arch depth which may be in arbitrary units.

5. The method of either of claims 1 or 2, in which measurements of said various foot characteristics comprise measurements of heel width, forefoot width at metatarsal, lengths from heel to first and fifth metatarsal heads, medial arch height, lateral arch height, distance from heel to medial and lateral arches, and arch depth.

6. The method of either of claims 1 or 2, in which measurements of said various foot characteristics comprise measurements of heel width, distance from heel to different metatarsal heads, lengthwise location of arch, arch height and arch depth, all of said measurements being in linear dimensional amounts with the possible exception of arch depth which may be in arbitrary units.

7. The method of either of claims 1 or 2, in which measurements of said various foot characteristics comprise measurements of heel width, forefoot width at metatarsal, lengths from heel to first and fifth metatarsal heads, medial arch height, lateral arch height, distance from heel to medial and lateral arches, and arch depth, all of said measurements being in linear dimensional amounts with the possible exception of arch depth which may be in arbitrary units.

8. In connection with correcting a problem with a patient's foot by providing the patient with an orthotic device which modifies the existing plantar surface of the patient's foot, the method of making such an orthotic device which comprises:
(a) taking measurements of various characteristics of the patient's foot directly from that foot, including measurements of aspects of its plantar surface, to produce a set of measurement quantities for selected parameters of said foot;
(b) creating a three-dimensional mathematical model of the plantar surface of the patient's foot from said set of measurements;
(c) modifying said three-dimensional mathematical model to reflect desired changes in the plantar surface of the patient's foot to correct the patient's problem;
(d) generating a set of appropriate milling machine commands corresponding to the modified three-dimensional mathematical model;
(e) using those commands to cause a milling machine to act on the exposed surface of a body to form on said surface a three-dimensional representation of the desired plantar surface of said patient's foot; and
(f) producing from said three-dimensional surface a correspondingly shaped orthotic to correct the patient's problem.
